(19) United States
(12) Patent Application Publication
(10) Pub. No.: US 2024/0144032 A1
(43) Pub. Date: May 2, 2024

(54) KNOWLEDGE GRAPH DATA FUSION

(71) Applicant: Alipay (Hangzhou) Information Technology Co., Ltd., Hangzhou (CN)

(72) Inventor: Lei LIANG, Hangzhou (CN)

(21) Appl. No.: 18/391,479

(22) Filed: Dec. 20, 2023

Related U.S. Application Data
(63) Continuation of application No. PCT/CN2022/109861, filed on Aug. 3, 2022.

(30) Foreign Application Priority Data
Sep. 16, 2021 (CN) 202111089403.4

(51) Int. Cl. G06N 5/02

(52) U.S. Cl. CPC G06N 5/02

(57) ABSTRACT

Implementations of the specification provide a knowledge graph data fusion method and system, and the method includes: obtaining a target entity field and a target relationship description, the target entity field and the target relationship description being selected from ontology definition data of two or more knowledge graphs; and then, obtaining data instances of related platforms or technology fields, and processing the obtained data instances based on a graph operator that is in ontology definition data of a fused knowledge graph and that is used to perform fusion processing on entity fields and relationship descriptions of different platforms or technology fields, to generate the fused knowledge graph.

### TECHNICAL FIELD

The present application relates to the field of data processing technologies, and in particular, to knowledge graph data fusion methods and systems.

### BACKGROUND

Different platforms or different technology fields separately have respective data. With the development of data management and data construction, it is hoped that data from multiple platforms and multiple technology fields can be fused and linked. A knowledge graph is a structured data expression manner, and can efficiently present knowledge information included in data. If knowledge from multiple platforms and multiple technology fields is linked by using the knowledge graph, data fusion efficiency can be effectively improved, and a business effect and calculation efficiency can be improved.

### SUMMARY

The specification is directed to a knowledge graph data fusion method and system that implement data fusion and linking.

An aspect of the specification provides a knowledge graph data fusion method, including: obtaining a target entity field and a target relationship description, the target entity field and the target relationship description being selected from ontology definition data of two or more knowledge graphs, and the ontology definition data of a knowledge graph including an entity field used to indicate an entity and a relationship description used to indicate a relationship between entities; determining one or more graph operators used to perform fusion processing on the target entity field and the target relationship description; and obtaining data instances corresponding to the target entity field and the target relationship description from the two or more knowledge graphs, and processing the data instances by using the graph operator to generate a fused knowledge graph.

An aspect of the specification provides a knowledge graph data fusion system, including: a target data acquisition module, configured to obtain a target entity field and a target relationship description, the target entity field and the target relationship description being selected from ontology definition data of two or more knowledge graphs, and the ontology definition data of a knowledge graph including an entity field used to indicate an entity and a relationship description used to indicate a relationship between entities; a graph operator determining module, configured to determine one or more graph operators used to perform fusion processing on the target entity field and the target relationship description; and a fused graph generation module, configured to: obtain data instances corresponding to the target entity field and the target relationship description from the two or more knowledge graphs, and process the data instances by using the graph operator to generate a fused knowledge graph.

An aspect of the specification provides a knowledge graph data fusion apparatus, including at least one storage medium and at least one processor, the at least one storage medium is configured to store computer instructions, and the at least one processor is configured to execute the computer instructions to implement the knowledge graph data fusion method.

An aspect of the specification provides a knowledge graph data processing method, including: specifying a target entity field and a target relationship description for a service provider, the target entity field and the target relationship description being selected from ontology definition data of two or more knowledge graphs, and the ontology definition data of a knowledge graph including an entity field used to indicate an entity and a relationship description used to indicate a relationship between entities; and obtaining one or more of a fused knowledge graph or a target task result from the service provider, the fused knowledge graph being generated by processing data instances by using a graph operator, the data instances being obtained from the two or more knowledge graphs based on the target entity field and the target relationship description, the target task result being obtained by processing the fused knowledge graph by using a target task algorithm, and the target task algorithm including a graph rule reasoning algorithm or a graph-based machine learning model prediction algorithm.

An aspect of the specification provides a knowledge graph data processing system, including: a target data specifying module, configured to specify a target entity field and a target relationship description for a service provider, the target entity field and the target relationship description being selected from ontology definition data of two or more knowledge graphs, and the ontology definition data of a knowledge graph including an entity field used to indicate an entity and a relationship description used to indicate a relationship between entities; and a result acquisition module, configured to obtain one or more of a fused knowledge graph or a target task result from the service provider, the fused knowledge graph being generated by processing data instances by using a graph operator, the data instance being obtained from the two or more knowledge graphs based on the target entity field and the target relationship description, the target task result being obtained by processing the fused knowledge graph by using a target task algorithm, and the target task algorithm including a graph rule reasoning algorithm or a graph-based machine learning model prediction algorithm.

An aspect of the specification provides a knowledge graph data processing apparatus, including at least one storage medium and at least one processor, the at least one storage medium is configured to store computer instructions, and the at least one processor is configured to execute the computer instructions to implement the knowledge graph data processing method.

### BRIEF DESCRIPTION OF DRAWINGS

The specification will be further illustrated by way of example implementations that will be described in detail with reference to the accompanying drawings. These implementations are not intended for limitation. In these implementations, same numbers represent same structures.

FIG. 1 is a schematic diagram illustrating an application scenario of a knowledge graph data fusion system according to some implementations of the specification;

FIG. 2 is a block diagram illustrating a knowledge graph data fusion system according to some implementations of the specification;

FIG. 3 is an example flowchart illustrating a knowledge graph data fusion method according to some implementations of the specification;

FIG. 4 is a schematic diagram illustrating ontology definition data of a fused knowledge graph according to some implementations of the specification;

FIG. 5 is an example flowchart illustrating generation of a fused knowledge graph according to some implementations of the specification; and

FIG. 6 is an example flowchart illustrating a knowledge graph data processing method according to some implementations of the specification.

### DESCRIPTION OF IMPLEMENTATIONS

To describe the technical solutions in the implementations of the specification more clearly, the following is a brief introduction of the accompanying drawings illustrating such technical solutions. Clearly, the accompanying drawings described below are some examples of implementations of the specification, and a person of ordinary skill in the art can further apply the specification to other similar scenarios based on these accompanying drawings without making innovative efforts. Unless clearly learned from the language environment or otherwise stated, same numbers in the drawings represent same structures or operations.

It should be understood that “system”, “apparatus”, “unit”, and/or “module” used in the specification are methods used to distinguish different components, elements, portions, parts, or assemblies of different levels. However, if other words can achieve the same purpose, the words can be replaced by other expressions.

As shown in the specification and the claims, unless an exception is explicitly indicated in the context, the words “one”, “a”, “an”, and/or “the” do not indicate singular numbers and can also include plural numbers. Generally, the terms “include” and “comprise” only indicate steps and elements that have been explicitly identified, and these steps and elements do not constitute exclusive listing, and the method or the device can also include other steps or elements.

A flowchart is used in the specification to describe operations performed by a system according to the implementations of the specification. It should be understood that a previous or subsequent operation is not necessarily performed precisely in a sequence. Instead, steps may be processed in a reverse sequence or processed simultaneously. In addition, other operations may be added to these processes, or a step or several operations may be removed from these processes.

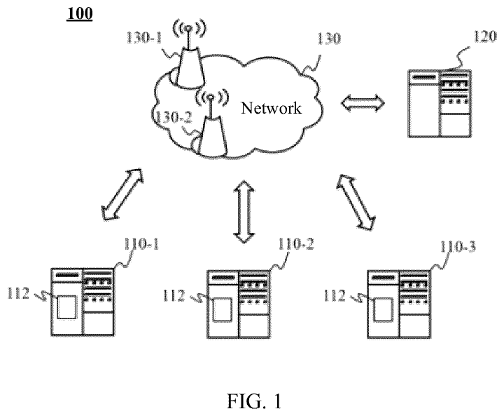

FIG. 1 is a schematic diagram illustrating an application scenario of a knowledge graph data fusion system according to one or more implementations of the specification.

A knowledge graph is a knowledge base including a series of entity instances (that is, instance data corresponding to entities) and relationships between the entity instances. An entity is an extensive abstraction of an objective individual, and can be a tangible object, for example, a person, a car, or a merchant, in the physical world, or can be an intangible object, for example, a discourse, a song, a movie, fund, or program code. The entity instance can be a real example corresponding to an abstract concept of the entity. For example, the person can be Amy, Mark, John, etc., the song can be Blue and White Porcelain, Nightingale, Swan Lake, etc., and the merchant can be merchant A, merchant B, merchant C, etc. In some implementations, the relationship between entity instances can also be considered as a relationship between corresponding entities. For example, there can a management relationship or an employment relationship between a person and a merchant. In some implementations, an entity instance in the knowledge graph can be represented by an node, and a relationship between entity instances can be represented by an edge connecting nodes.

The knowledge graph can correspondingly have ontology definition data that is also referred to as a schema of the knowledge graph. The ontology definition data of a knowledge graph is data that indicate entities and relationships between entities that are included in the knowledge graph, and can represent semantic information of instance data of ontology of the knowledge graph. The ontology definition data of the knowledge graph can guide collection of the instance data and graph composition based on the instance data to obtain the knowledge graph (also referred to as an instance graph). Therefore, in some implementations, the ontology definition data of the knowledge graph can include entity fields for defining entities. The entity field can be understood as an entity name or an entity representation. For example, the entity field can be “company entity”, “user”, “city”, etc., and a value of the entity field can be the previous entity instance. The entity field can correspond to multiple attribute fields, and the attribute field can be abstraction of entity description information. For example, the attribute field can be “address”, “age”, “registration capital”, etc., and a value of the attribute field can be a specific description of an entity instance corresponding to the attribute field, for example, “No. 11 Jianshe Road”, “28 years old”, or “five million”. In some implementations, the ontology definition data of the knowledge graph can include a relationship description used to indicate a relationship between entities, and the relationship description can be abstraction of a type of the relationship between entities, for example, “employment relationship”, “parent-subsidiary company relationship”, or “parent-child relationship”. In some implementations, the relationship description can further include a relationship attribute, and the relationship attribute is used to further describe the relationship description. For example, “employment relationship” can be “temporary employment” or “formal employment”, and “parent-subsidiary company relationship” can further include “wholly-owned holding relationship”, “partially-owned holding relationship”, etc. It can be determined, by using the relationship description, whether there is an edge between two entity instances during construction of the knowledge graph. In some implementations, a graph operator can be further determined. The graph operator is used to identify entity instances from a large quantity of data instances and determine a relationship between the entity instances based on the entity definition or the relationship description. The graph operator can also be understood as a graph computing algorithm or method, and is used to perform a data processing operation for graph construction. The graph operator can be implemented in various forms such as a data processing/operation unit, program code, or a machine learning model. In some implementations, for input data of an operator, the operator can perform corresponding data processing/operation, complete data conversion, and output converted data. In some implementations, the graph operator can be considered as an algorithm or a method established on the ontology definition data (including the entity definition and the relationship description) of the knowledge graph, or as a part of the ontology definition data.

The knowledge graph data fusion system provided in the specification can be applied to a scenario related to data processing in multiple platforms or multiple technology fields. For example, the knowledge graph data fusion system can be applied to a scenario of calculating a service task (such as determining a fund risk of a natural person) based on data in multiple technology fields such as security, insurance, payment, and wealth.

Different platforms or different technology fields separately store respective data. For example, each platform or technology field can record respective service data in a form of a knowledge graph or a data table. When knowledge data from different platforms and different technology fields is fused and linked, a service effect, service efficiency, and calculation efficiency can be improved. Fusion and linking of data from multiple platforms and technology fields can be implemented by constructing a knowledge graph in which knowledge data from multiple platforms and technology fields is linked.

In some implementations, a data table can be obtained from each platform or technology field (e.g., a data instance is recorded in a form of a two-dimensional table, and the data table can include a field and a field value, e.g., a data instance of a corresponding field), and further, a fused knowledge graph is created based on the obtained data table (for example, a graph operator is constructed for graph calculation). In an operation of constructing a fused knowledge graph in the present implementation, the fused knowledge graph is recreated based on data instances in different platforms or technology fields, and an existing knowledge graph in different platforms or technology fields cannot be used, so that costs for implementing data fusion in a graph construction process during each time of data fusion are high, and data maintenance costs are also high. In addition, because a graph is reconstructed and a development cycle is long, it is very likely that a data instance obtained from each platform or technology field is stored on a corresponding disk for use, that is, data in each platform or technology field falls on a disk of another business party, and data security cannot be ensured.

In view of the above situation, some implementations of the specification provide a more efficient knowledge graph data fusion method and system. Ontology definition data (e.g., entity-defined data such as a target entity field, inter-entity relationship-defined data such as a target relationship description, and a graph operator for performing fusion processing on the target entity field and the target relationship description) of a fused knowledge graph can be created based on ontology definition data (e.g., entity-defined data such as an entity field, and inter-entity relationship-defined data such as an inter-entity relationship description) of each existing knowledge graph in each platform or technology field, and then data instances in related platforms or technology fields are obtained, and the obtained data instances are processed based on the ontology definition data of the fused knowledge graph, to obtain the fused knowledge graph. Based on the knowledge graph data fusion method and system described in some implementations of the specification, construction of the fused knowledge graph can be automated and standardized, a construction process is more efficient, and costs of data fusion and data maintenance are reduced. Further, the knowledge graph data fusion method and system described in some implementations of the specification can be executed in a trusted environment, so that data (e.g., a data instance) in each platform or technology field does not fall on a disk of another business party, data privacy is protected, and data security is ensured.

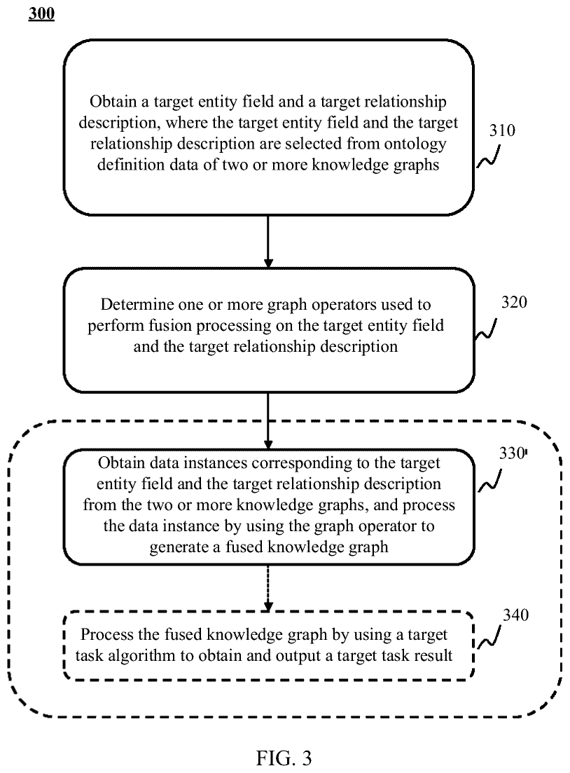

In some implementations, the knowledge graph data fusion method and system provided in some implementations of the specification can be implemented based on a service provider, a user, and a business party. The user can be any individual or institution, such as an individual or an enterprise. The business party can be any individual or institution, and the business party has one or more corresponding platforms or technology fields, and has respective business data. In some implementations, the business party can record business data of the business party in a form of a knowledge graph or a data table. The service provider can be a platform or system used to implement the knowledge graph data fusion method and system, or can be any individual or institution that provides a platform or system for implementing the knowledge graph data fusion method and system. In some application scenarios, the service provider can provide a knowledge graph data fusion service for the user based on knowledge graphs of one or more business parties (as a knowledge graph provider). The service provider can obtain ontology definition data of a knowledge graph from one or more business parties, and present the ontology definition data to the user, and the user can determine, from ontology definition data of two or more knowledge graphs, an entity field and a relationship description that are required by the user in a fusion service, and can specify (for example, notify or send) the entity field and the relationship description as a target entity field and a target relationship description to the service provider. For specific content of the ontology definition data, refer to FIG. 3 and related descriptions. In some implementations, one of two or more business parties can be used as fused knowledge graph data requested and obtained by the suer from the service provider and related to knowledge graph data of another business party.

In some implementations, the service provider can obtain the target entity field and the target relationship description, for example, a target entity field and a target relationship description that are specified by the user, and the service provider can further obtain data instances corresponding to the target entity field and the target relationship description from two or more knowledge graphs, and process the data instances by using the graph operator to generate a fused knowledge graph. In some implementations, one or more graph operators used to perform fusion processing on target entity fields and target relationship descriptions can be generated by the service provider, or can be generated by the user and sent to the service provider. The service provider can further process the fused knowledge graph by using a target task algorithm to obtain a target task result and output the target task result to the user. The target task algorithm can be determined by the service provider, or can be specified by the user for the service provider.

In some implementations, the user can further obtain data of the fused knowledge graph from the service provider based on a permission of the user. For example, the user obtains a data use permission from a corresponding service provider, and the service provider can verify the permission of the user. If the verification succeeds, the fused knowledge graph can be sent to the user.

As shown in FIG. 1, an application scenario 100 of a knowledge graph data fusion system can include multiple servers such as servers 110-1, 110-2, and 110-3, a processing device 120, and a network 130.

The multiple servers, such as servers 110-1, 110-2, and 110-3, can respectively correspond to multiple platforms or technology fields. Servers 110-1, 110-2, 110-3 . . . can be used to manage resources and process data and/or information from at least one component of a current system or an external data source (for example, a cloud data center). In some implementations, each of servers 110-1, 110-2, 110-3, . . . can be a single server or a server group. The server group can be centralized or distributed (for example, server 110-1 can be a distributed system), and can be dedicated or can be served simultaneously by other devices or systems. In some implementations, servers 110-1, 110-2, 110-3, . . . can be regional or remote. In some implementations, servers 110-1, 110-2, 110-3, . . . can be implemented on a cloud platform or provided in a virtual manner. As an example only, the cloud platform can include private cloud, public cloud, hybrid cloud, community cloud, distributed cloud, internal cloud, multi-tier cloud, and the like, or any combination thereof.

Any one or more of servers 110-1, 110-2, 110-3, . . . can include a processor 112. The processor 112 can process data and/or information obtained from another device or system component. The processor can execute a program instruction based on the data, the information, and/or a processing result, to perform one or more functions described in the present application. In some implementations, the processor 112 can include one or more processing sub-devices (for example, a single-core processing device or a multi-core processing device). As an example only, the processor 112 can include a central processing unit (CPU), an application-specific integrated circuit (ASIC), an application-specific instruction processor (ASIP), a graphics processing unit (GPU), a physical processing unit (PPU), a digital signal processor (DSP), a field programmable gate array (FPGA), a programmable logic device (PLD), a controller, a microcontroller unit, a reduced instruction set computer (RISC), a microprocessor, and the like, or any combination of more processors.

In some implementations, any one of more of servers 110-1, 110-2, 110-3, . . . can store data of a corresponding platform or technology field, such as a data instance, ontology definition data of a knowledge graph, and a knowledge graph. In some implementations, any one or more of servers 110-1, 110-2, 110-3, . . . can obtain ontology definition data of knowledge graphs of one or more other platforms or technology fields, and can further obtain ontology definition data of a fused knowledge graph. In some implementations, servers 110-1, 110-2, 110-3, . . . can correspond to different business parties.

The processing device 120 can process data and/or information obtained from another device or system component. The processing device 120 can execute a program instruction based on the data, the information, and/or a processing result to perform one or more functions described in the present application. In some implementations, the processing device 120 can include one or more sub-processing devices (for example, a single-core processing device or a multi-core processing device). As an example only, the processing device 120 can include a central processing unit (CPU), an application-specific integrated circuit (ASIC), an application-specific instruction processor (ASIP), a graphics processing unit (GPU), a physical processing unit (PPU), a digital signal processor (DSP), a field programmable gate array (FPGA), a programmable logic device (PLD), a controller, a microcontroller unit, a reduced instruction set computer (RISC), a microprocessor, and the like, or any combination of more processors. In some implementations, the processing device 120 can belong to the service provider.

The network 130 can connect system components and/or connect the system to an external part. The network 130 enables communication between system components and between the system and the external part to facilitate exchange of data and/or information. In some implementations, the network 130 can be any one or more of a wired network or a wireless network. For example, the network 130 can include a cable network, an optical fiber network, a telecommunications network, the Internet, a local area network (LAN), a wide area network (WAN), a wireless local area network (WLAN), a metropolitan area network (MAN), a public switched telephone network (PSTN), a Bluetooth network, a ZigBee network (ZigBee), near field communication (NFC), an in-device bus, an in-device line, a cable connection, or any combination thereof. In some implementations, a network connection between parts of the system can be in one of the above manners or can be in multiple manners. In some implementations, the network 130 can be various topologies such as point-to-point, converged, and centralized, or a combination of multiple topologies. In some implementations, the network 130 can include one or more network access points. For example, the network 130 can include a wired or wireless network access point, such as a base station and/or network switching points 130-1, 130-2, . . . . Through these network access points, one or more components of the system 100 can be connected to the network 130 to exchange data and/or information.

In some implementations, the processing device 120 can obtain ontology definition data (for example, entity-defined data such as an entity field or inter-entity relationship-defined data such as an inter-entity relationship description) of two or more knowledge graphs from two or more of servers 110-1, 110-2, 110-3, . . . through the network 130 to create ontology definition data (for example, entity-defined data such as a target entity field, inter-entity relationship-defined data such as a target relationship description, and a graph operator for performing fusion processing on target entity fields and target relationship descriptions) of a fused knowledge graph, and then obtain data instances of related platforms or technology fields from servers 110-1, 110-2, 110-3, . . . through the network 130, and process the obtained data instance based on the ontology definition data of the fused knowledge graph to obtain the fused knowledge graph. In some implementations, the processing device 120 can be a dedicated device for fusing data in a knowledge graph, and is configured to receive a data fusion request from a user (not shown in the figure) or another platform or technology field (for example, any one or more of servers 110-1, 110-2, 110-3, . . . ) and return fused data. In some implementations, the user or any one or more of servers 110-1, 110-2, 110-3, . . . can further send a target task and/or a target task algorithm to the processing device 120 through the network 130. The processing device 120 can process the fused knowledge graph by using the target task and/or the target task algorithm, to obtain and output a target task result. The user or any one or more of servers 110-1, 110-2, 110-3, . . . can accept, through the network 130, the target task result output by the processing device 120. In some implementations, the processing device 120 can be deployed on one of servers 110-1, 110-2, 110-3, . . . , or one of servers 110-1, 110-2, 110-3, . . . can be used as the processing device 120 to implement functions of the processing device 120. In other words, in some application scenarios, the business party can also be used as the service provider to provide a knowledge graph data fusion service.

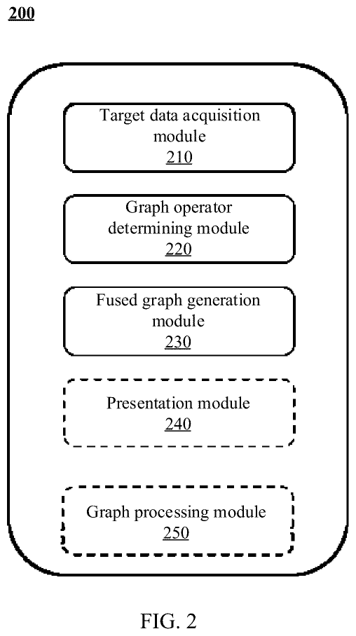

FIG. 2 is a block diagram illustrating a knowledge graph data fusion system according to some implementations of the specification.

In some implementations, a knowledge graph data fusion system 200 can be implemented on one of servers 110-1, 110-2, 110-3, . . . or the processing device 120, and can include a target data acquisition module 210, a graph operator determining module 220, and a fused graph generation module 230. In some implementations, the knowledge graph data fusion system 200 can further include a presentation module 240. In some implementations, the knowledge graph data fusion system 200 can further include a graph processing module 250.

In some implementations, the target data acquisition module 210 can be configured to obtain a target entity field and a target relationship description. The target entity field and the target relationship description are selected from ontology definition data of two or more knowledge graphs, and the ontology definition data of a knowledge graph includes an entity field used to indicate an entity and a relationship description used to indicate a relationship between entities.

In some implementations, the graph operator determining module 220 can be configured to determine one or more graph operators used to perform fusion processing on each target entity field and each target relationship description. In some implementations, the entity field corresponds to one or more attribute fields. In some implementations, a graph operator is used to implement one or more of the following operations: performing expression standardization processing on an instance value of an attribute field corresponding to the target entity field; fusing two or more target entity fields to obtain a fused entity field, where an attribute field corresponding to the fused entity field is obtained based on an attribute field corresponding to at least one of the two or more target entity fields, and a related relationship description of the fused entity field includes a related target relationship description of each of the two or more target entity fields; establishing a relationship description for target entities based on an attribute field corresponding to at least one of two target entity fields corresponding to the two target entities; and invoking a natural language processing model to determine similar instances in data instances, so as to fuse the similar instances in the data instances.

In some implementations, the fused graph generation module 230 can be configured to: obtain data instances corresponding to the target entity field and the target relationship description from two or more knowledge graphs, and process the data instances by using the graph operator to generate the fused knowledge graph. In some implementations, the fused graph generation module 230 can be further configured to: determine a target entity field and a target relationship description that are related to the graph operator, as an entity field and a relationship description of a minimal sub-graph; obtain, from each knowledge graph, data instances corresponding to the entity field and the relationship description of the minimal sub-graph; process, by using the graph operator, the data instances corresponding to the entity field and the relationship description of the minimal sub-graph, to obtain the minimal sub-graph; and obtain, from each knowledge graph, data instances corresponding to a target entity field and a target relationship description other than the entity field and the relationship description of the minimal sub-graph, to obtain a sub-graph other than the minimal sub-graph of the fused knowledge graph.

In some implementations, the presentation module 240 can be configured to: obtain ontology definition data of the fused knowledge graph based on the target entity field, the target relationship description, and the one or more graph operators, and express the ontology definition data of the fused knowledge graph in an image form of a knowledge graph.

In some implementations, the graph processing module 250 can be configured to process the fused knowledge graph by using a target task algorithm to obtain and output a target task result. The target task algorithm includes one or more of a graph rule reasoning algorithm or a graph-based machine learning model prediction algorithm.

In some implementations, the fused graph generation module 230 can be deployed in a trusted execution environment.

In some implementations, the graph processing module 250 can be deployed in a trusted execution environment.

It should be understood that the shown system and modules of the system can be implemented in various manners. For example, in some implementations, the system and modules of the system can be implemented by hardware, software, or a combination of software and hardware. A hardware part can be implemented by using dedicated logic, and a software part can be stored in a memory and executed by an appropriate instruction execution system, such as a microprocessor or dedicated design hardware. A person skilled in the art can understand that the above method and system can be implemented by using a computer executable instruction and/or included in processor control code for implementation, for example, such code is provided on a carrier medium such as a disk, a CD, or a DVD-ROM, a programmable memory such as a read-only memory (firmware), or a data carrier such as an optical or electronic signal carrier. The system and modules of the system in the specification can be implemented not only by a hardware circuit of a very large scale integrated circuit or a gate array, a semiconductor such as a logic chip or a transistor, or a programmable hardware device such as a field programmable gate array or a programmable logic device, but also by software executed by various types of processors, and can also be implemented by a combination of the above hardware circuits and software (for example, firmware).

It should be noted that the above descriptions of the system and the modules of the system are for ease of description only, and the specification cannot be limited to the scope of the implementations. It can be understood that, after understanding the principle of the system, a person skilled in the art can arbitrarily combine the modules or form a subsystem to connect to other modules without departing from the principle.

FIG. 3 is an example flowchart illustrating a knowledge graph data fusion method according to some implementations of the specification.

In some implementations, a method 300 can be performed by the processing device 120. In some implementations, the method 300 can be implemented by a knowledge graph data fusion system 200 deployed on the processing device 120.

As shown in FIG. 3, the method 300 can include the following steps:

Step 310: Obtain a target entity field and a target relationship description, where the target entity field and the target relationship description are selected from ontology definition data of two or more knowledge graphs.

In some implementations, step 310 can be performed by a target data acquisition module 210.

In some implementations, the ontology definition data of the two or more knowledge graphs can come from two or more platforms or technology fields, and the two or more platforms or technology fields can correspondingly belong to one or more knowledge graph providers, such as business parties. In some implementations, knowledge graphs of different platforms or technology fields can have different data representation standards. For example, formats of attribute fields can be different; or entity fields defined in a knowledge graph schema of a same entity in different platforms or technology fields are different, for example, an entity is a company, a schema in technology field A is defined as an entity field “CRO.company”, and a schema in technology field B is defined as an entity field “CompanyV2”.

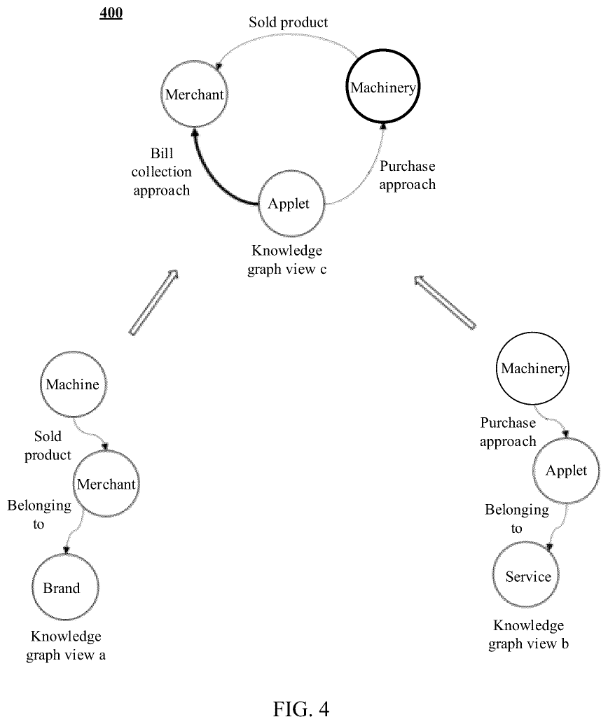

The ontology definition data of the knowledge graph can be visualized and presented. For a schematic diagram of visualization of the ontology definition data of the knowledge graph and more content, refer to FIG. 4 and related descriptions.

In some implementations, the target data acquisition module 210 can select a required entity field and a required relationship description from ontology definition data of knowledge graphs of two or more platforms/technology fields based on practical requirements such as a practical objective, and the selected entity field and the selected relationship description are referred to as the target entity field and the target relationship description. For example, if the practical objective is to determine a capital risk of a merchant, entity fields such as merchant, commodity, applicant, and manager that are related to the merchant can be selected from ontology definition data of a knowledge graph of the insurance technology field as target entity fields and related relationship descriptions “belonging to”, “management”, and “insurance application” can be selected as target relationship descriptions, and entity fields such as merchant, commodity, payee, and manager that are related to the merchant can be selected from ontology definition data of a knowledge graph of the payment technology field as target entity fields and related relationship descriptions “belonging to”, “management”, and “payment” can be selected as target relationship descriptions. In some implementations, a relationship description selected from ontology definition data of the same knowledge graph should be related to an entity field selected at the same time. In other words, entity fields related to a relationship description selected from ontology definition data of a knowledge graph are all in a selected target entity field. On the contrary, a relationship description related to the entity field selected from the ontology definition data of the knowledge graph may not be included in a selected target relationship description.

In some implementations, a user can select a target entity field and a target relationship description from ontology definition data of knowledge graphs of two or more platforms/technology fields.

Step 320: Determine one or more graph operators used to perform fusion processing on the target entity field and the target relationship description.

In some implementations, step 320 can be performed by a graph operator determining module 220.

To construct a fused knowledge graph, a graph operator used to perform fusion processing on target entity fields and target relationship descriptions can be determined. For general descriptions of the graph operator, refer to the above related descriptions. The graph operator used for fusion processing is various graph operators used to implement fusion and/or connection processing of data corresponding to target entity fields and target relationship descriptions. For example, various operators for fusing similar target entities into one entity, establishing a relationship between two unassociated target entities, and performing expression standardization processing on attribute information can be included. For more content of the graph operator, refer to step 330 and related descriptions.

In some implementations, the graph operator used to perform fusion processing on target entity fields and target relationship descriptions can be generated by a processing device 120 or can be generated by the user and provided by the user for the processing device 120.

It can be understood that knowledge graphs of different platforms/technology fields can include different ontology definition data, that is, different target entity fields and different target relationship descriptions, and ontology definition data of knowledge graphs of different platforms/technology fields are not linked, for example, target entity fields are not associated. By determining one or more graph operators that are used to perform fusion processing on target entity fields and target relationship descriptions, ontology definition data of knowledge graphs of different platforms/technology fields can be fused and associated to obtain ontology definition data that is used to construct the fused knowledge graph. Therefore, data instances corresponding to knowledge graphs of different platforms/technology fields can be fused and/or linked based on the ontology definition data of the fused knowledge graph.

The ontology definition data of the knowledge graph is overview or abstraction of a data instance, and if the ontology definition data of the knowledge graph is publicly fused into each platform/technology field, a sensitive data instance is not disclosed.

In some implementations, the ontology definition data of the fused knowledge graph can be expressed in an image form of a knowledge graph. The image of a knowledge graph can be graphically displayed in a display interface (for example, a terminal interface). For example, a node is used to represent the target entity field or a fused entity field, and an edge connecting two nodes is used to represent a relationship description between entities, including a new relationship description created based on the graph operator. In some implementations, the processing device 120 can send the ontology definition data of the fused knowledge graph to the user, to intuitively present an ontology framework of a to-be-generated knowledge graph to the user, so that it is convenient for the user to adjust or improve the ontology definition data of the fused knowledge graph, and graph composition efficiency is improved. For more content of the image of a knowledge graph, refer to FIG. 4 and related descriptions. Details are omitted herein for simplicity.

Step 330: Obtain data instances corresponding to the target entity field and the target relationship description from the two or more knowledge graphs, and process the data instance by using the graph operator to generate a fused knowledge graph.

In some implementations, step 330 can be performed by a fused graph generation module 230.

In some implementations, after it is determined that the ontology definition data of the fused knowledge graph is obtained, a corresponding data instance can be obtained from a knowledge graph of a corresponding platform or technology field based on the ontology definition data of the fused knowledge graph, such as the target entity field, the target relationship description, and an attribute field corresponding to the target entity field. The data instance can include an entity instance corresponding to the target entity field, an attribute value, and a relationship description between entity instances.

In some implementations, a data processing operation/calculation implemented by one or more graph operators can include performing expression standardization processing on an instance value of the attribute field corresponding to the target entity field. The expression standardization processing can be standardization processing for unifying a data format of the instance value of the attribute field (for example, the instance value of the attribute field is a numerical value, a character, or a binary number), a data expression constraint condition (for example, a constraint condition of an attribute field of a time type is that an instance value is a date or a value of a 24-hour time type, and a constraint condition of an attribute field of an amount type is that an instance value is a value in units of US dollar or a value in units of RMB), a data expression type (for example, the instance value of the attribute field is integer data or floating point data), and the like, so that attribute values of entity fields from different platforms or technology fields have a unified expression or measurement manner.

In some implementations, a data processing operation/calculation implemented by one or more graph operators can include fusing two or more target entity fields to obtain a fused entity field. It can be understood that knowledge data from different platforms/technology fields is fused and linked based on fusion of ontology definition data of different knowledge graphs, for example, fusion of two or more target entity fields. In some implementations, target entity fields with similar or same semantics can be fused. For example, the ontology definition data of the fused knowledge graph includes a target entity field “CRO.company” from the insurance technology field and a target entity field “CompanyV2” from the payment technology field, and “CRO.company” and “CompanyV2” can be fused to obtain a fused entity field. The fused entity field can be represented by any one of two or more target entity fields that are fused, for example, “CRO.Company” or “CompanyV2”, or another entity field that can represent semantics of two or more target entity fields that are fused. In some implementations, after the two or more target entity fields are fused to obtain the fused entity field, attribute fields corresponding to the two or more target entity fields that are fused and a corresponding relationship description are also adjusted to adapt to the fused entity field. An attribute field corresponding to the fused entity field can be a union set of the attribute fields corresponding to the two or more target entity fields that are fused, or a part of the union set. For example, the attribute field corresponding to the fused entity field can be all or some attribute fields corresponding to a specific target entity field that is fused. A relationship description related to the fused entity field can include a target relationship description related to each of the two or more target entity fields that are fused. A relationship description related to the fused entity field can include a target relationship description related to each of the two or more target entity fields that are fused.

In some implementations, the similarity between target entity fields can be calculated, and two or more target entity fields whose similarity meets a condition (for example, the similarity is greater than a threshold or a similarity ranking is TopN) can be fused to obtain a fused entity field.

In some implementations, the similarity between target entity fields can be calculated by using a tf-idf algorithm or a text similarity algorithm for calculating a vector distance between text (the distance can include but is not limited to a cosine distance, a Euclidean distance, a Manhattan distance, a Mahalanobis distance, or a Minkovski distance).

In some implementations, the similarity between two target entity fields can be determined by using a semantic similarity prediction model, for example, the similarity between target entity fields can be calculated based on models such as BERT, Transformer, and ESIM. In some implementations, whether two or more target entity fields are similar or the same can be further determined based on an attribute field corresponding to the target entity field. A BERT model is used as an example. Text (which can include a field name of a target entity field and a corresponding attribute field name) corresponding to two or more target entity fields can be entered into the BERT model, and the BERT model can determine text vectors of the two or more target entity fields, and calculate the semantic similarity between the text vectors. The BERT model can output a score of the similarity between the text vectors, that is, can use the obtained similarity score as the similarity between the target entity fields.

A fusion graph operator fusion (CRO.Company, CompanyV2) is used as an example. The fusion graph operator is defined to fuse a target entity field CRO.Company and a target entity field CompanyV2 in knowledge graph schemas from different platforms. The graph operator can correspond to a segment of program code, and is invoked during generation of the fused knowledge graph based on the data instance, to process an entity instance corresponding to “CRO.Company” and an entity instance corresponding to “CompanyV2” into instances in the same entity field, that is, a fused entity field.

In some implementations, a data processing operation/calculation implemented by one or more graph operators can include establishing a relationship description between two target entity fields based on an attribute field corresponding to at least one of the two corresponding target entities. As described above, an attribute field corresponding to an entity field can represent a definition of further description information of the entity field, such as a name, an address, and a type. In some implementations, the attribute field corresponding to the target entity field can be used to determine whether there is a new association relationship between two unassociated target entities, and further, a relationship description between the two target entities can be established. For example, an attribute field corresponding to a target entity field “CRO.Company” from the insurance technology field includes “address”, and a target entity field “City” comes from the payment technology field. A relationship description between “CRO.Company” and “City” can be established based on the attribute field “address” corresponding to “CRO.Company”, for example, the relationship description is established as city. For an example, if a target entity field “commodity” from the manufacturing technology field corresponds to an attribute field “commodity type”, and a target entity field “merchant” from the sales technology field corresponds to an attribute field “main business range”, a relationship description between “commodity” and “merchant” can be established based on the attribute fields of the two target entity fields, for example, the relationship description is established as a sales relationship.

A link graph operator link (CRO.Company, inCity, City, address) is used as an example. The link graph operator can indicate a relationship description between “CRO.Company” and “City” based on the target entity field “CRO.Company”, an attribute field “address” of “CRO.Company”, and the target entity field “city”. When this operator is invoked to process the target entity fields “CRO.Company” and “City” and data instances corresponding to “CRO.company” and “City”, a relationship description between the entity instance “CRO.Company” and the entity instance “City” can be established as “inCity” based on a value of the attribute field “address” of the entity instance “CRO.Company”.

In some implementations, the data processing operation/calculation implemented by one or more graph operators can further include determining similar instances in the data instances to fuse the similar instances in the data instances. For example, if data instances corresponding to the fused entity field include two similar data instances “hotel D” and “budget hotel D”, “hotel D” and “budget hotel D” can be fused by using the graph operator to obtain a fused data instance, for example, fused to obtain “hotel D”. In some implementations, interface invoking code used to invoke a natural language processing model for data processing can be added to the graph operator, so that the natural language processing model is invoked to implement the above data processing.

In some implementations, when the natural language processing model is invoked to determine similar instances in the data instances, the similarity between a value of an entity field of the data instance and/or a value of an attribute field of the data instance can be determined by invoking the natural language processing model, and two or more data instances whose similarity meets a condition (for example, the similarity is greater than a threshold or a similarity ranking is TopN) are determined as similar instances. In some implementations, the natural language model can be a neural network model used for natural language processing, for example, a model such as BERT, Transformer, or ESIM. A method similar to the method for determining the similarity between target entity fields can be used to obtain the similarity between data instances by using the neural network model to process the value of the entity field of the data instance and/or the value of the attribute field of the data instance. Details are omitted herein for simplicity.

In some implementations, when data instances corresponding to a target entity field and a target relationship description that are involved in a determined graph operator are processed by using the graph operator, the fused knowledge graph can be generated.

In some implementations, after the fused knowledge graph is generated, the fused knowledge graph can be processed based on a practical objective task (for example, determining a capital risk of a merchant), to obtain a target task result (for example, a capital risk type of a merchant is medium high risk), and output to a business party or another user, to implement more efficient and accurate service task calculation based on linked knowledge data of multiple platforms/multiple technology fields.

In some implementations, the method 300 can further include step 340: Process the fused knowledge graph by using a target task algorithm to obtain and output a target task result. In some implementations, step 340 can be performed by a graph processing module 250.

The target task algorithm can be various algorithms used to perform target task calculation, for example, can include a graph rule reasoning algorithm and a graph-based machine learning model prediction algorithm.

The graph rule reasoning algorithm is an algorithm that performs rule reasoning based on knowledge data such as an entity instance and a relationship between entity instances of a knowledge graph to obtain a target task result, for example, query/reason a relationship between two or more instances based on the fused knowledge graph, for example, relatives of Mark or merchants managed by a specific manager.

The graph-based machine learning model prediction algorithm is an algorithm for predicting a target task result by processing a knowledge graph by using a machine learning model, for example, processing the fused knowledge graph based on a graph convolutional network, to obtain an expression of the fused knowledge graph such as a vector representation corresponding to an entity, and then entities in the fused knowledge graph are classified based on the expression, to obtain a prediction result of a category to which some entities of the fused knowledge graph belong.

In some implementations, the target task algorithm can be determined by the processing device 120 (that is, a service provider), or can be specified by a user.

In some implementations, at least some of the steps in the knowledge graph data fusion method shown in some implementations of the specification are performed in a trusted environment, for example, data instances corresponding to the target entity field and the target relationship description are obtained from each knowledge graph, the data instances are processed by using the graph operator to generate a fused knowledge graph, and the fused knowledge graph is processed based on, for example, the practical objective task, to obtain a target task result.

In some implementations, the trusted environment can be a trusted execution environment (TEE) or an execution environment in which a device memory that supports full memory calculation can isolate data from the outside world. For example, the outside world cannot access data in the trusted environment or control code executed in the trusted environment. The full memory calculation means that data is stored in a memory in advance, and during calculation, the data is directly read from and written into the memory, and an intermediate result generated by calculation is not dropped on a disk.

In some implementations, processing the data instances by using the graph operator to generate the fused knowledge graph and for an example, processing the fused knowledge graph based on the practical objective task to obtain the target task result can both be performed based on full memory calculation.

In some implementations, intermediate results generated by the method steps performed in the trusted execution environment can be destroyed after calculation is completed, for example, the data instances corresponding to the target entity field and the target relationship description obtained from each knowledge graph, the fused knowledge graph generated by processing the data instances by using the graph operator, and an intermediate result of processing the fused knowledge graph based on the practical objective task.

At least some steps of the knowledge graph data fusion method are performed in the trusted execution environment or one or more modules in the knowledge graph data fusion system 200 are deployed in the trusted execution environment, so that data instances of various platforms/technology fields do not fall on a disk of another business party, thereby ensuring security and privacy of data of all parties while implementing efficient data fusion.

In some implementations, the processing device 120 can output a fused knowledge graph or the target task result to the user based on permissions of the user, to obtain a knowledge graph fusion service from the service provider.

FIG. 4 is a schematic diagram illustrating visualization 400 of the ontology definition data of the fused knowledge graph according to some implementations of the specification.

The ontology definition data of the fused knowledge graph shown in FIG. 4 can be presented on a presentation interface (for example, an interface such as a system, a platform, or an application) in an image form of a knowledge graph (for example, KGView). In some implementations, a visualization process of the ontology definition data of the fused knowledge graph can be implemented by the presentation module 240.

FIG. 4 shows two images “a” and “b” of a knowledge graph that are corresponding to ontology definition data of knowledge graphs of two technology fields A and B, and an image “c” of a knowledge graph that is corresponding to ontology definition data of a fused knowledge graph that is obtained from the ontology definition data of the two technology fields. In the image of a knowledge graph, an entity field is represented by a node (in FIG. 4, a circle represents a node), and an inter-entity relationship description is represented by an edge connecting two nodes (in FIG. 4, a line connecting circles is referred to as an edge).

As shown in FIG. 4, target entity fields “machine” and “merchant” and a target relationship description “sold product” can be selected from ontology definition data of a knowledge graph of the technology field A, target entity fields “machinery” and “applet” are selected from ontology definition data of a knowledge graph of the technology field B, and a graph operator used to fuse “machine” and “machinery” and a graph operator used to establish a relationship description between “merchant” and “applet” as “bill collection method” are determined. Based on the selected target entity fields, the target relationship description, and the determined graph operators, an image “c” of a knowledge graph corresponding to ontology definition data of a fused knowledge graph is obtained, where “machinery” is a fused entity field obtained by fusing “machine” and “machinery”, and “bill collection method” is a relationship description represented by an edge established between “merchant” and “applet”.

In a process of processing the data instances corresponding to the target entity field and the target relationship description by using the graph operator to generate the fused knowledge graph, to further improve generation efficiency of the fused knowledge graph and reduce operation costs or operation overheads, other implementations of the specification provide a method for generating the fused knowledge graph.

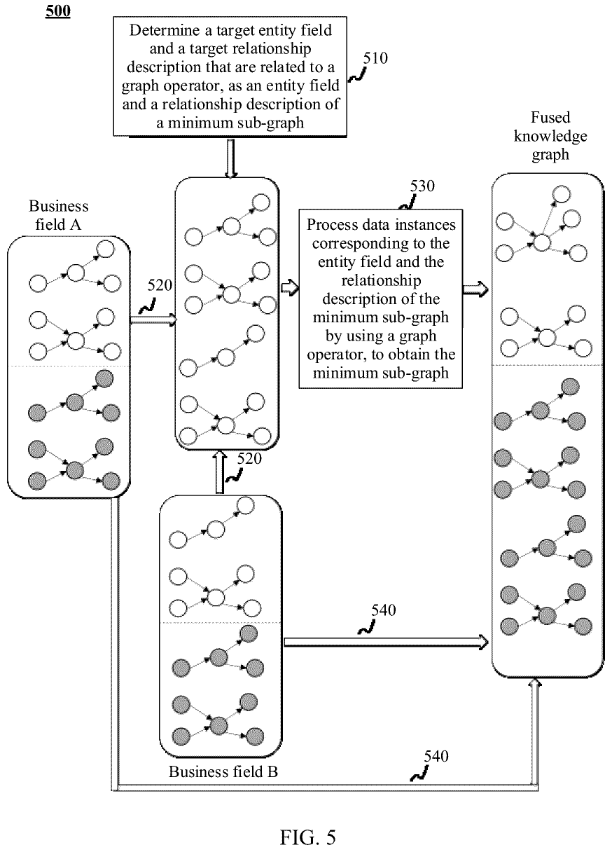

FIG. 5 is an example flowchart illustrating generation of the fused knowledge graph according to other implementations of the specification.

In some implementations, a method 500 can be performed by the processing device 120. In some implementations, the method 500 can be implemented by a fused graph generation module 230 deployed on the processing device 120.

As shown in FIG. 5, the method 500 can include the following steps:

Step 510: Determine a target entity field and a target relationship description that are related to a graph operator, as an entity field and a relationship description of a minimal sub-graph.

As described above, the graph operator is used to perform fusion processing on the target entity field and the target relationship description, that is, the graph operator includes the target entity field and the target relationship description that are to be fused. In some implementations, in ontology definition data of a fused knowledge graph, only some target entity fields and some target relationship descriptions may be fused. To save computing resources, target entity fields and target relationship descriptions that are related to the graph operator can be determined from the ontology definition data of the fused knowledge graph, and the target entity fields and the target relationship descriptions are used as entity fields and relationship descriptions of the minimal sub-graph. The minimal sub-graph is a knowledge graph sub-graph constructed based on data instances corresponding to the target entity fields and the target relationships description that are related to the graph operator. In some implementations, target entity fields and target relationship descriptions that are related to all graph operators in the ontology definition data of the fused knowledge graph can be used as entity fields and relationship descriptions of the minimal sub-graph. In other words, one fused knowledge graph corresponds to one minimal sub-graph. In some implementations, target entity fields and target relationship descriptions that are separately related to different graph operators in the ontology definition data of the fused knowledge graph can be used as entity fields and relationship descriptions of different minimal sub-graphs. In other words, one fused knowledge graph corresponds to multiple minimal sub-graphs.

Step 520: Obtain data instances corresponding to the entity field and the relationship description of the minimal sub-graph from each knowledge graph.

In some implementations, after entity fields and relationship descriptions that are included in one or more minimal sub-graphs are determined, the data instances corresponding to the entity field and the relationship description of the minimal sub-graph can be obtained from each knowledge graph. As shown in FIG. 5, white sub-graphs of technology fields A and B are used for subsequently generating a fused knowledge graph. Compared with obtaining data instances corresponding to all target entity fields and all target relationship descriptions of the fused knowledge graph for subsequent processing, in the present implementation, data processing efficiency of the fused knowledge graph can be improved.

Step 530: Process the data instances corresponding to the entity field and the relationship description of the minimal sub-graph by using a graph operator, to obtain the minimal sub-graph.

In some implementations, the data instances corresponding to the entity field and the relationship description of the minimal sub-graph can be processed by using the graph operator, to obtain a minimal sub-graph that fuses data instances corresponding to some target entity fields and target relationship descriptions, as shown by a white sub-graph in the fused knowledge graph in FIG. 5.

In some implementations, data instances corresponding to entity fields and relationship descriptions corresponding to multiple minimal sub-graphs can be separately processed by using multiple graph operators, to obtain the multiple minimal sub-graphs.

Step 540: Obtain, from each knowledge graph, data instances corresponding to a target entity field and a target relationship description other than the entity field and the relationship description of the minimal sub-graph, to obtain a sub-graph other than the minimal sub-graph of the fused knowledge graph.

In some implementations, after one or more minimal sub-graphs that are related to the graph operator of the fused knowledge graph are generated, fusion processing of the data instances corresponding to the target entity field and the target relationship description that are to be fused in the fused knowledge graph is completed, that is, knowledge data of multiple platforms/multiple technology fields is linked.

After each minimal sub-graph of the fused knowledge graph is obtained, the data instances corresponding to the target entity field and the target relationship description other than the entity field and the relationship description of the minimal sub-graph can be obtained from each knowledge graph of each platform/technology field, as shown by gray sub-graphs of technology fields A and B in FIG. 5, to obtain a sub-graph other than the minimal sub-graph in the fused knowledge graph, as shown by a gray sub-graph in the fused knowledge graph in FIG. 5. The minimal sub-graph and the sub-graph other than the minimal sub-graph are loaded together, to obtain a fused knowledge graph including complete knowledge data.

It can be understood that the data instances corresponding to the entity field and the relationship description of the minimal sub-graph are some data instances in the fused knowledge graph that are to be processed, and data instances corresponding to the other entity fields and relationship descriptions in the fused knowledge graph and a relationship between the data instances can be directly obtained from each existing knowledge graph. In the present implementation, knowledge data of an existing knowledge graph can be fully utilized, and calculation costs of generating the fused knowledge graph can be significantly reduced.

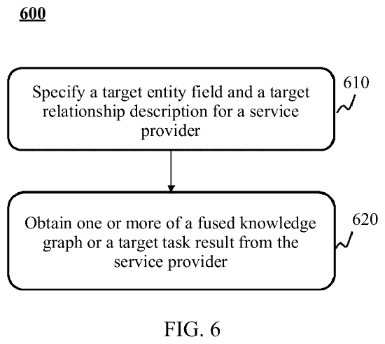

In some implementations, the user can request a knowledge graph fusion service from a service provider and obtain fused data from the service provider. In some implementations, the user can also make customization requirements, such as specifying the target entity field, the target relationship description, and a target task algorithm used to process the fused knowledge graph. FIG. 6 is an example flowchart illustrating a knowledge graph data processing method according to other implementations of the specification.

In some implementations, the user can implement one or more steps in a method 600 by using a device such as a terminal.

As shown in FIG. 6, the method 600 can include the following steps:

Step 610: Specify a target entity field and a target relationship description for a service provider.

In some implementations, the user can select the target entity field and the target relationship description from ontology definition data of two or more knowledge graphs, and specify the target entity field and the target relationship description for the service provider. The ontology definition data of the two or more knowledge graphs can come from two or more platforms or technology fields, and the two or more platforms or technology fields can correspondingly belong to one or more knowledge graph providers such as business parties. For more content of the ontology definition data of the knowledge graph, the target entity field, and the target relationship description, refer to step 310 and related descriptions.

Step 620: Obtain one or more of a fused knowledge graph or a target task result from the service provider.

In some implementations, the service provider can obtain the fused knowledge graph and the target task result by using the method 300, and send the fused knowledge graph and/or the target task result to the user.

In some implementations, the user can further obtain ontology definition data of the fused knowledge graph that is expressed in an image form of a knowledge graph from the service provider. For more content of the ontology definition data of the fused knowledge graph that is expressed in an image form of a knowledge graph, refer to FIG. 4 and related descriptions.

An aspect of the specification provides a knowledge graph data processing system.

In some implementations, the knowledge graph data processing system can include a target data specifying module and a result acquisition module.

In some implementations, the target data specifying module can be configured to specify a target entity field and a target relationship description for a service provider, where the target entity field and the target relationship description are selected from ontology definition data of two or more knowledge graphs, and the ontology definition data of a knowledge graph includes an entity field used to indicate an entity and a relationship description used to indicate a relationship between entities.

In some implementations, the knowledge graph data processing system can further include an operator determining module that can be configured to: generate one or more graph operators that are used to perform fusion processing on target entity fields and target relationship descriptions, and send the one or more graph operators to the service provider.

In some implementations, the knowledge graph data processing system can further include an algorithm determining module that can be configured to specify a target task algorithm for the service provider.

In some implementations, the result acquisition module can be configured to obtain one or more of a fused knowledge graph or a target task result from the service provider. The fused knowledge graph is generated by processing data instances by using a graph operator, and the data instances are obtained from the two or more knowledge graphs based on the target entity field and the target relationship description. The target task result is obtained by processing the fused knowledge graph by using a target task algorithm. The target task algorithm includes a graph rule reasoning algorithm or a graph-based machine learning model prediction algorithm.

In some implementations, the result acquisition module can be further configured to obtain ontology definition data of the fused knowledge graph that is expressed in an image form of a knowledge graph from the service provider. The ontology definition data of the fused knowledge graph is obtained based on the target entity field, the target relationship description, and the one or more graph operators.

It should be understood that the shown system and modules of the system can be implemented in various manners. For example, in some implementations, the system and modules of the system can be implemented by hardware, software, or a combination of software and hardware. A hardware part can be implemented by using dedicated logic, and a software part can be stored in a memory and executed by an appropriate instruction execution system, such as a microprocessor or dedicated design hardware. A person skilled in the art can understand that the above method and system can be implemented by using a computer executable instruction and/or included in processor control code for implementation, for example, such code is provided on a carrier medium such as a disk, a CD, or a DVD-ROM, a programmable memory such as a read-only memory (firmware), or a data carrier such as an optical or electronic signal carrier. The system and modules of the system in the specification can be implemented not only by a hardware circuit of a very large scale integrated circuit or a gate array, a semiconductor such as a logic chip or a transistor, or a programmable hardware device such as a field programmable gate array or a programmable logic device, but also by software executed by various types of processors, and can also be implemented by a combination of the above hardware circuits and software (for example, firmware).

It should be noted that the above descriptions of the system and the modules of the system are for ease of description only, and the specification cannot be limited to the scope of the implementations. It can be understood that, after understanding the principle of the system, a person skilled in the art can arbitrarily combine the modules or form a subsystem to connect to other modules without departing from the principle.

An implementation of the specification further provides a knowledge graph data fusion apparatus, including at least one storage medium and at least one processor. The at least one storage medium is configured to store computer instructions. The at least one processor is configured to execute the computer instructions to implement the knowledge graph data fusion method.

An aspect of the specification provides a knowledge graph data processing apparatus, including at least one storage medium and at least one processor. The at least one storage medium is configured to store computer instructions. The at least one processor is configured to execute the computer instructions to implement the knowledge graph data processing method.

Beneficial effects that may be brought by the implementations of the specification include but are not limited to: (1) Ontology definition data of a fused knowledge graph is created based on ontology definition data of each existing knowledge graph of each platform or each technology field, and then, data instances of related platforms or technology fields are obtained, and the obtained data instances are processed based on a graph operator that is in the ontology definition data of the fused knowledge graph and that is used to perform fusion processing on entity fields and relationship descriptions of different platforms or technology fields, to generate the fused knowledge graph, so that construction of the fused knowledge graph can be automated and standardized, a construction process is more efficient, and data fusion and data maintenance costs are reduced. (2) The knowledge graph data fusion method can be performed in a trusted environment, so that data privacy is effectively protected while data fusion efficiency is improved. (3) In a fused knowledge graph generation method based on a minimal sub-graph, knowledge data of an existing knowledge graph can be fully used, and calculation costs are further reduced. It should be noted that different beneficial effects can be generated in different implementations, and in different implementations, possible beneficial effects can be one of or a combination of several of the above beneficial effects, or can be any other possible beneficial effect.

Basic concepts have been described above. Clearly, for a person skilled in the art, the above detailed disclosure is merely an example, but does not constitute a limitation on the specification. Although not explicitly stated herein, a person skilled in the art may make various modifications, improvements, and amendments to the specification. Such modifications, improvements, and amendments are proposed in the specification. Such modifications, improvements, and amendments are proposed in the specification. Therefore, such modifications, improvements, and amendments still fall within the spirit and scope of the example implementations of the specification.

In addition, specific words are used in the specification to describe the implementations of the specification. For example, “one implementation”, “an implementation”, and/or “some implementations” mean a feature, structure, or characteristic related to at least one implementation of the specification. Therefore, it should be emphasized and noted that “an implementation”, “one implementation”, or “an alternative implementation” mentioned twice or more times in different locations in the specification does not necessarily refer to the same implementation. In addition, some features, structures, or characteristics in one or more implementations of the specification may be appropriately combined.

In addition, a person skilled in the art can understand that aspects of the specification can be described through several patentable categories or circumstances, including any new and useful combination of processes, machines, products, or substances, or any new and useful improvement to them. Correspondingly, aspects of the specification can be completely executed by hardware or completely executed by software (including firmware, resident software, microcode, and the like), or can be executed by a combination of hardware and software. The above hardware or software can be referred to as “data block”, “module”, “engine”, “unit”, “component”, or “system”. In addition, aspects of the specification can be represented by a computer product located in one or more computer readable media, and the product includes computer-readable program code.

The computer storage medium can include a propagated data signal that includes computer program code, for example, on a baseband or as a part of a carrier. The propagated signal can have multiple representation forms, including an electromagnetic form, an optical form, or the like, or a proper combined form. The computer storage medium can be any computer-readable medium other than the computer-readable storage medium, and the medium can be connected to an instruction execution system, apparatus, or device to implement a program for communication, propagation, or transmission. Program code on the computer storage medium can be propagated through any suitable medium, including radio, a cable, a fiber optic cable, RF, or a similar medium, or any combination of the above media.

The computer program code required for each part of the operations of the specification can be written in any one or more program languages, including object-oriented programming languages such as Java, Scala, Smalltalk, Eiffel, JADE, Emerald, C++, C #, VB.NET, and Python, conventional programming languages such as C programming language, Visual Basic, Fortran 2003, Perl, COBOL 2002, PHP, and ABAP, dynamic programming languages such as Python, Ruby, and Groovy, or other programming languages. The program code can run entirely on a user computer, or run as an independent software package on a user computer, or partially on a user computer and partially on a remote computer, or run entirely on a remote computer or a processing device. In the latter case, the remote computer can be connected to the user computer in any network form, such as a local area network (LAN) or a wide area network (WAN), or connected to an external computer (for example, through the Internet), or in a cloud computing environment, or used as a service, such as software as a service (SaaS).

In addition, unless expressly stated in the claims, the sequence of the processing elements and sequences described in the specification, the use of numbers and letters, or the use of other names are not intended to limit the sequence of the processes and methods described in the specification. Although some currently considered useful implementations of the invention are discussed in various examples in the above disclosure, it should be understood that such details are merely used for illustrative purposes. The appended claims are not limited to the disclosed implementations, and instead, the claims are intended to cover all amendments and equivalent combinations that conform to the essence and scope of the implementations of the specification. For example, although the components of the system described above can be implemented by a hardware device, they can be implemented only by a software solution, such as installing the described system on an existing processing device or a mobile device.

Similarly, it should be noted that, to simplify the description disclosed in the specification and thereby help understand one or more implementations of the present invention, in the above descriptions of the implementations of the specification, various features are sometimes incorporated into one implementation, the accompanying drawings, or descriptions thereof.

Numbers describing the composition, attributes, and quantities are used in some implementations. It should be understood that such numbers used for the description of the implementations are modified in some examples by modifiers such as “about”, “approximately”, or “generally”. Unless otherwise stated, “about”, “approximately”, or “generally” indicates that the number allows a change in ±20%. Correspondingly, in some implementations, numeric parameters used in the specification and claims are approximations, and the approximations may change based on features required by some implementations. In some implementations, the numeric parameters should take into account the specified significant digits and use a general digit retention method. Although in some implementations of the specification, numeric domains and parameters used to determine the ranges of the implementations are approximations, in specific implementations, such values are set as precisely as possible in a feasible range.

Each patent, patent application, and patent application publication, and other materials, such as articles, books, instructions, publications, documents, etc. that are referenced by the specification are incorporated into the specification herein by reference in its entirety, except for the application history documents that are inconsistent with or conflict with the content of the specification, and the documents limiting a widest scope of the claims of the specification (the documents currently or later attached to the specification). It should be noted that, if the description, definition, and/or use of a term in the auxiliary material of the specification is inconsistent or conflicts with the content of the specification, the description, definition, and/or use of the term in the specification shall prevail.

Finally, it should be understood that the implementations described in the specification are merely used to describe the principles of the implementations of the specification. Other variations may all fall within the scope of the specification. Therefore, as an example rather than a limitation, alternative configurations of the implementations of the specification may be considered to be consistent with the teachings of the specification. Correspondingly, the implementations of the specification are not limited to the implementations explicitly introduced and described in the specification.

What is claimed is:

1. A method, comprising:
obtaining a target entity field and a target relationship description from ontology definition data of two or more knowledge graphs, the ontology definition data of a knowledge graph including an entity field used to indicate an entity and a relationship description used to indicate a relationship between entities;
determining one or more graph operators used to perform fusion processing on the target entity field and the target relationship description;
obtaining data instances corresponding to the target entity field and the target relationship description from the two or more knowledge graphs; and
processing the data instances by using the one or more graph operators to generate a fused knowledge graph.

2. The method according to claim 1, comprising receiving user input on the target entity field and the target relationship description.

3. The method according to claim 1, wherein the determining the one or more graph operators includes:
determining the one or more graph operators based on a user input, or
determining the one or more graph operators that are automatically generated.

4. The method according to claim 1, further comprising:
obtaining ontology definition data of the fused knowledge graph based on the target entity field, the target relationship description, and the one or more graph operators, and presenting the ontology definition data of the fused knowledge graph in an image form of a knowledge graph.

5. The method according to claim 1, wherein the entity field corresponds to one or more attribute fields, and
wherein the processing the data instances by using the one or more graph operators to generate a fused knowledge graph includes one or more of:
performing expression standardization processing on an instance value of an attribute field corresponding to the target entity field;
fusing two or more target entity fields to obtain a fused entity field, an attribute field corresponding to the fused entity field being obtained based on an attribute field corresponding to at least one of the two or more target entity fields, and a relationship description related to the fused entity field including a target relationship description related to each of the two or more target entity fields;
establishing a relationship description for two target entities based on an attribute field corresponding to at least one of two target entity fields corresponding to the two target entities; or
invoking a natural language processing model to determine similar instances in the data instances, to fuse the similar instances in the data instances.

6. The method according to claim 1, wherein the obtaining the data instances corresponding to the target entity field and the target relationship description from the two or more knowledge graphs, includes:
determining a target entity field and a target relationship description that are related to the graph operator, as an entity field and a relationship description of a minimal sub-graph; and
obtaining, from each knowledge graph, data instances corresponding to the entity field and the relationship description of the minimal sub-graph; and
wherein the processing the data instances by using the graph operator to generate the fused knowledge graph includes:
processing, by using the graph operator, the data instances corresponding to the entity field and the relationship description of the minimal sub-graph, to obtain the minimal sub-graph; and
obtaining, from each knowledge graph, data instances corresponding to a target entity field and the target relationship description other than the entity field and the relationship description of the minimal sub-graph, to obtain a sub-graph other than the minimal sub-graph of the fused knowledge graph.

7. The method according to claim 1, wherein the obtaining the data instances corresponding to the target entity field and the target relationship description from the two or more knowledge graphs, and processing the data instances by using the graph operator to generate the fused knowledge graph is executed in a trusted environment.

8. The method according to claim 7, further comprising:
in the trusted environment,
processing the fused knowledge graph by using a target task algorithm to obtain and output a target task result, the target task algorithm including one or more of a graph rule reasoning algorithm or a graph-based machine learning model prediction algorithm.

9. The method according to claim 8, wherein the target task algorithm is specified by a user.

10. The method according to claim 1, wherein the two or more knowledge graphs are received from one or more knowledge graph providers.

11. A computing system having one or more processors and one or more storage devices, the one or more storage devices individually or collectively storing computer executable instructions, which when executable by the one or more processors, enable the one or more processors to, individually or collectively, implement acts comprising:
obtaining a target entity field and a target relationship description from ontology definition data of two or more knowledge graphs, the ontology definition data of a knowledge graph including an entity field used to indicate an entity and a relationship description used to indicate a relationship between entities;
determining one or more graph operators used to perform fusion processing on the target entity field and the target relationship description;
obtaining data instances corresponding to the target entity field and the target relationship description from the two or more knowledge graphs; and
processing the data instances by using the one or more graph operators to generate a fused knowledge graph.

12. The computing system according to claim 11, wherein the determining the one or more graph operators includes:
determining the one or more graph operators based on a user input, or
determining the one or more graph operators that are automatically generated.

13. The computing system according to claim 11, wherein the acts further comprise:
obtaining ontology definition data of the fused knowledge graph based on the target entity field, the target relationship description, and the one or more graph operators, and presenting the ontology definition data of the fused knowledge graph in an image form of a knowledge graph.

14. The method according to claim 11, wherein the entity field corresponds to one or more attribute fields, and
wherein the processing the data instances by using the one or more graph operators to generate a fused knowledge graph includes one or more of:
performing expression standardization processing on an instance value of an attribute field corresponding to the target entity field;
fusing two or more target entity fields to obtain a fused entity field, an attribute field corresponding to the fused entity field being obtained based on an attribute field corresponding to at least one of the two or more target entity fields, and a relationship description related to the fused entity field including a target relationship description related to each of the two or more target entity fields;
establishing a relationship description for two target entities based on an attribute field corresponding to at least one of two target entity fields corresponding to the two target entities; or
invoking a natural language processing model to determine similar instances in the data instances, to fuse the similar instances in the data instances.

15. The computer system according to claim 11, wherein the obtaining the data instances corresponding to the target entity field and the target relationship description from the two or more knowledge graphs, includes:
determining a target entity field and a target relationship description that are related to the graph operator, as an entity field and a relationship description of a minimal sub-graph; and
obtaining, from each knowledge graph, data instances corresponding to the entity field and the relationship description of the minimal sub-graph; and
wherein the processing the data instances by using the graph operator to generate the fused knowledge graph includes:
processing, by using the graph operator, the data instances corresponding to the entity field and the relationship description of the minimal sub-graph, to obtain the minimal sub-graph; and
obtaining, from each knowledge graph, data instances corresponding to a target entity field and the target relationship description other than the entity field and the relationship description of the minimal sub-graph, to obtain a sub-graph other than the minimal sub-graph of the fused knowledge graph.

16. The computer system according to claim 11, wherein the obtaining the data instances corresponding to the target entity field and the target relationship description from the two or more knowledge graphs, and processing the data instances by using the graph operator to generate the fused knowledge graph is executed in a trusted environment.

17. The computer system according to claim 16, wherein the acts further comprise:
in the trusted environment,
processing the fused knowledge graph by using a target task algorithm to obtain and output a target task result, the target task algorithm including one or more of a graph rule reasoning algorithm or a graph-based machine learning model prediction algorithm.

18. A non-transitory storage medium having computer executable instructions stored thereon, the computer executable instructions when executable by the one or more processors, enabling the one or more processors to, individually or collectively, implement acts comprising:
obtaining a target entity field and a target relationship description from ontology definition data of two or more knowledge graphs, the ontology definition data of a knowledge graph including an entity field used to indicate an entity and a relationship description used to indicate a relationship between entities;
determining one or more graph operators used to perform fusion processing on the target entity field and the target relationship description;
obtaining data instances corresponding to the target entity field and the target relationship description from the two or more knowledge graphs; and
processing the data instances by using the one or more graph operators to generate a fused knowledge graph.

19. The non-transitory storage medium according to claim 18, wherein the acts further comprise:
obtaining ontology definition data of the fused knowledge graph based on the target entity field, the target relationship description, and the one or more graph operators, and presenting the ontology definition data of the fused knowledge graph in an image form of a knowledge graph.

20. The non-transitory storage medium according to claim 18, wherein the obtaining the data instances corresponding to the target entity field and the target relationship description from the two or more knowledge graphs, includes:
determining a target entity field and a target relationship description that are related to the graph operator, as an entity field and a relationship description of a minimal sub-graph; and
obtaining, from each knowledge graph, data instances corresponding to the entity field and the relationship description of the minimal sub-graph; and
wherein the processing the data instances by using the graph operator to generate the fused knowledge graph includes:
processing, by using the graph operator, the data instances corresponding to the entity field and the relationship description of the minimal sub-graph, to obtain the minimal sub-graph; and
obtaining, from each knowledge graph, data instances corresponding to a target entity field and the target relationship description other than the entity field and the relationship description of the minimal sub-graph, to obtain a sub-graph other than the minimal sub-graph of the fused knowledge graph.
